(19) United States
(12) Patent Application Publication
(10) Pub. No.: US 2018/0229195 A1
(43) Pub. Date: Aug. 16, 2018

(54) Connector devices (3) for mixing and stirring viscous liquids

(71) Applicant: Dennis Phillip Malloy, Mount Prospect, IL (US)

(72) Inventor: Dennis Phillip Malloy, Mount Prospect, IL (US)

(21) Appl. No.: 15/432,829

(22) Filed: Feb. 14, 2017

(51) Int. Cl. B01F 15/00; B01F 3/10; B01F 7/00; B01F 13/00; A47L 13/11

(52) U.S. Cl. CPC B01F 15/0048; B01F 3/10; B01F 7/00033; B01F 2215/005; B01F 15/00058; B01F 13/0028; A47L 13/11; B01F 7/0025

(57) ABSTRACT

Connector devices (3) for mixing and stirring viscous liquids is disclosed. The connectors are an injection molded plastic and are recyclable. The first device is a one piece mixing connector combining a hexaxial shaft for power drill attachment by insertion into the adjustable drill chuck and a cavity insertable slotted bracket located at the opposite end of a shaft for insertion of a mixing stick. The assembled parts are then lowered into a container and the drill activated by the trigger turning the assembly and stirring the liquid. The second device is a one piece plastic, recyclable, rectangle “ring” that is put on the stick before mixing and slowly removed in the opposite direction of installation thus using the squeegee effect to push the unused material back into the container for future use. The third device is an extension where the end of the first stick is inserted in the cavity insertable slot and a second stick is inserted in opposite end's cavity insertable slot to double the length for mixing in larger, deeper containers.

Prior Publications Data

| | | | |
|---|---|---|---|
| 6863430 | March | 2005 | Berube |
| 6902315 | June | 2005 | Hutchinson |
| 6955227 | October | 2005 | Motosko |
| D512292 | December | 2005 | Martin |
| 7451832 | November | 2008 | DeIvo |
| 7473026 | January | 2009 | Clawson et al. |
| 7484879 | February | 2009 | Hamilton, Jr. |
| 7513678 | April | 2009 | Venus |
| 2002/0015357 | February | 2002 | Langevin, Jr. et al. |
| 2005/0047268 | March | 2005 | Chen |
| 2005/0047269 | March | 2005 | Chen |
| 2005/0052947 | March | 2005 | Claussen et al. |
| 2005/0088907 | April | 2005 | Vanek |
| 2007/0086271 | April | 2007 | Hamilton |
| 2008/0247267 | October | 2008 | Clawson et al. |

Foreign Patent Documents

| | | |
|---|---|---|
| 3321532 | December 1984 | DE |

### FIELD OF CLASSIFICATION SEARCH

CPC . . . B01F B44D 3/06

USPC . . . 366/129

### OTHER REFERENCES

Alibaba.com, Paint Mixers, Hangzhou John Industry and Trade, Products, Apr. 27, 2005, pp. 1-3, http://john-tools.en.alibaba.com/group/50048360/Paint.sub.-Mixers.html. cited by other .

Red Devil, Inc., Painter's tools, sealants, caulk, home repair tools, Paint Mixers, Apr. 27, 2005, p. 1,

http://www.reddevil.com/products.cfm?c=pt&cat=15. cited by other.

Corner Hardware.com, Drill Powered Paint Mixers, ShurLine 1 Gal. Paint Mixer, Apr. 27, 2005, p. 1, http://www.cornerhardware.com/item.sub.-264689/Shur-Line/Shur-Line/ShurL-ine-1-Gal-Paint. cited by other.

Do It Yourself.com, Shop for Power Driven Mixer by Hyde Tools, Apr. 27, 2005, p. 1, http://doityourself.com/store/6576144.htm. cited by other.

### BRIEF SUMMARY OF INVENTION

In view of the above, these connecting devices are provided for the benefit of the user and the environment. The benefits to the user will be the time saved in using these devices versus alternatives, the product saved, the time and water saved in clean up. Time will be saved by assembly, use and easy clean up of unused product. This saves money. Less water used in clean up. This also saves money. Benefits to the environment include less use of water, and less product being flushed into the water system. Additional environmental benefit would be the material used to produce the connectors is recyclable. Another feature to both end user and environment is it is small in size versus alternatives. The benefit of a small footprint is less for shipping and handling equating a cost savings to end user as well as less waste in a smaller package for recycling. In another aspect of the invention, instructions describe a method for using the connectors as designed to achieve the desired benefits listed above. An example of the method are the instructions for use. The squeegee ring is first inserted over the paint stick and slid up the stick about 2.2 inches. The stick is then inserted into the slot of the drill connector, so the ring is touching the connector. The drill connector hex shaft is then inserted into the chuck of a ⅜ variable speed drill and the chuck tightened. The devices are ready for mixing. The stick is inserted into the paint only up to the devices. The connecting devices should not come in contact with the liquid to facilitate disassemble for cleanup. When desired consistency is attained the assembly is lifted from the paint and allowed to drip. The squeegee ring is grasped and slid down in the direction of the paint bucket which will squeegee the unused paint back into the bucket. The ring can then be dropped into a small container of water. The stick is then removed from the hex slotted connector and discarded or allowed to dry for possible future use.

### DETAILED DESCRIPTION AND SPECIFICATION OF THE INVENTION

These connector devices are for mixing and stirring viscous liquids, such as paint, adhesives, grout, sealers, tile mortar, sheet rock joint compound and cements comprising of an axial shaft for securing to a powered drill and an insertable bracket at the other end of the axial shaft. (Device 1.) Device 2. is a cleaning squeegee “ring” that removes excess material, paint for example to reduce waste in cleanup. Devise 3. is an extension “channel” that increases the length from 12″ to 24″.

A disposable wooden or plastic paint stick (12″ long) made available at paint retailers for no charge is inserted in the device 1. for mixing and stirring the paint or other material. The inserted stick is then removed. The cleaning “ring” (device 2.) then slides off the stick removing access material to be reused thus reducing waste and pollution. The stick can then be dried and reused or disposed of. The extension bracket (device 3.) is used to connect a second stick to increase the length of the stirrer to over 25.″

### BACKGROUND OF THE INVENTION

The viscosity of a fluid is a measure of its resistance to gradual deformation by shear stress or tensile stress. For liquids, it corresponds to the informal concept of “thickness”; for example, honey has a much higher viscosity than water. Viscosity is a property of the fluid which opposes the relative motion between the two surfaces of the fluid in a fluid that are moving at different velocities. When the fluid is forced through a tube, the particles which compose the fluid generally move more quickly near the tube's axis and more slowly near its walls; therefore some stress (such as a pressure difference between the two ends of the tube) is needed to overcome the friction between particle layers to keep the fluid moving. For a given velocity pattern, the stress required is proportional to the fluid's viscosity. A fluid that has no resistance, zero viscosity, to shear stress is known as an ideal or inviscid fluid. Otherwise, all fluids have positive viscosity, and are technically said to be viscous or viscid. In common parlance, however, a liquid is said to be viscous if its viscosity is substantially greater than that of water. A fluid with a relatively high viscosity, such as pitch, may appear to be a solid. Sheer stress is important as related to the material the invention is comprised of and the items used in method with the invention to accomplish the task.

Possibly the earliest evidence of man mixing two items together in a liquid is cave paintings. For example and illustration this invention and method of mixing will use paint as the viscous liquid. As cited above there are many viscous liquids. This invention may only be limited to viscous liquids beyond the limit as to its sheer stress.

Color has been with us for more than 20,000 years. Evidence survives in early cave paintings and the ancient Chinese are considered to have brought its manufacture and use to a state of perfection tens of thousands of years ago. Paint is comprised of various dyes and pigments and a liquid to obtain a desired color. Overtime paint will separate and require mixing to return it to a usable state. After World War II, chemists working for major paint manufacturers began developing new formulas for paints. Along with these developments came a burgeoning awareness among American consumers that many of these developments posed a growing health problem. The lead and mercury in the paint was highly toxic, as were the many solvents (now called VOCs and HAPs), mildewcides, germicides, and numerous other additives. While heritage building and art restorers have maintained the use of traditional, natural paints, in order to maintain the integrity of the colours and textures, now the general public are involved in a global revolution as they seek to reclaim a more natural way of being and living, in harmony with the environment, breathing freely . This invention is socially responsible and addresses environmental issues.

The most well-known method of stirring or mixing paint by hand is either by using a stirring stick, or by vigorously shaking the paint can, which can be difficult and requires strenuous effort to do properly. A can shaker used at many paint retailers is an expensive piece of equipment. Other drill stirrer attachments that are previously cited in prior publication data are difficult to clean, bulky and costly to ship, and expensive to purchase and replace. There is a need in the art for a way of mixing viscous fluids, economically, environmentally responsibly, and making use of a sustainable existing product.

### BRIEF DESCRIPTION OF THE DRAWINGS

In the accompanying figures, like elements are identified by like reference numerals among the several preferred embodiments of the present invention.

FIG. 1 is a overhead view of the connector with the axial shaft as lying on a flat surface.

FIG. 2 is a top view of the connector with the axial shaft showing the cavity insertable slot for a paint stir stick or similar stirrer.

FIG. 2A is a perspective view showing the top with the cavity slot and opposite end axial shaft.

FIG. 3 is a bottom view of the connector of FIG. 1, displaying the centered hexaxial shaft.

FIG. 3A is a perspective view showing the hexaxial shaft at the base for drill connection.

FIG. 4 is a side view of the connector of FIG. 1, showing the depth of the connector.

FIG. 4A is a perspective view with a cross cut view of the cavity insertable slot.

FIG. 5 is a side view of the squeegee ring. (if turned over it is the same mirror image.)

FIG. 5A is a top and bottom view of the ends of the squeegee ring showing the insert able slot. Each end of the ring is a mirror image of the other.

FIG. 6 is a side view of the extension connector. (if turned over it is the same.)

FIG. 6A is a top and bottom view (mirror images) of the ends of the squeegee ring showing the insertable slot.

### DETAILED DESCRIPTION OF THE DRAWINGS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof. As used in this specification, the term connector shall mean a device for joining two parts together. As used in this specification, the term squeegee ring shall mean the device placed over the paint stick that can slide the length of the paint stick. When used as instructed the ring will squeegee the paint on the stick after stirring back into the container of paint. The name “squeegee” may come from the word “squeegee”, meaning press or squeeze. This squeegee effect is a result of the compressing ring against the paint to move it with the aid of gravity to accumulate quickly and return to the can.

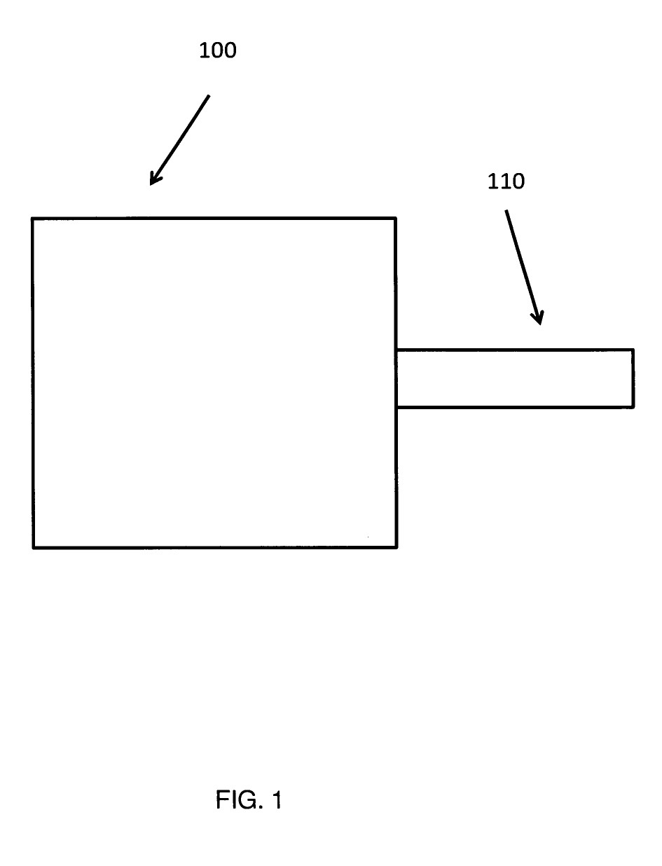

FIG. 1 is a side view of the axial shaft/slotted bracket as it lay on its length and wide side on a flat surface. The slotted bracket 100 has dimensions of 2.5″ length, by 1.58″ wide, by 0.5″ deep. The slot in the bracket will be described later in detail. If the device is turned over the opposite side is a mirror image. 110 The axial shaft of the connector 120, is a ⅜″ hexagon for secure connection to a drill chuck. The axial shaft is 1.5″ long. The total length of the connector in FIG. 1 is 4″.

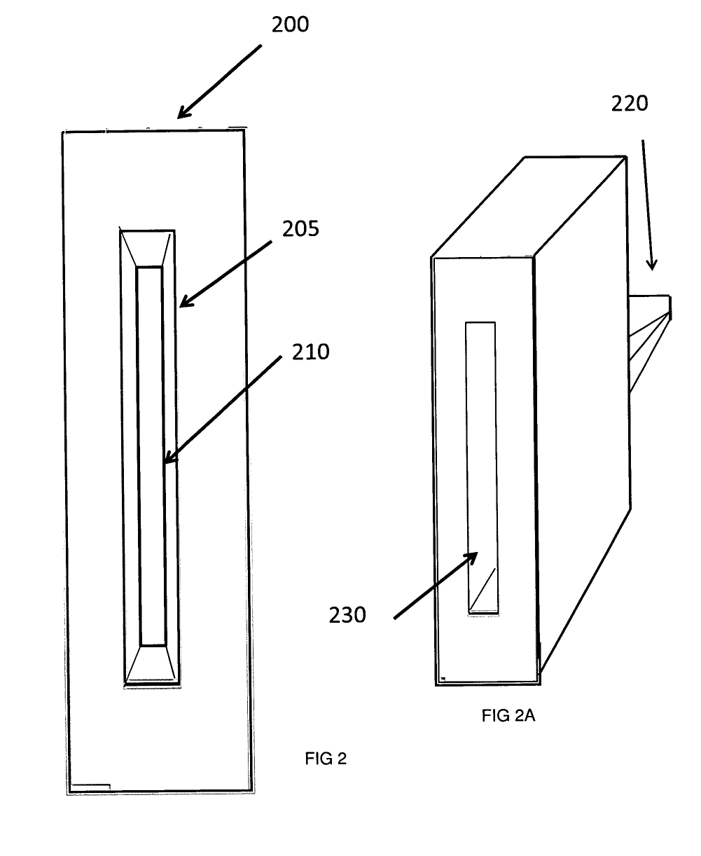

FIG. 2 is a top view of the axial shaft/slotted bracket as it lay on its depth side on a flat surface. 200 The slotted bracket 100 has dimensions of 2.5″ length, by 1.58″ wide, by 0.5″ deep. The depth 200 is 0.5″. The slot 210 channel is 0.15″ inches wide. FIG. 2A is a perspective view of the axial shaft/slotted bracket on its depth side. 220 shows the 0.5″ depth. The insertable cavity 230 is centered in the end of the device that is opposite of the axial shaft and is 0.15″ deep.

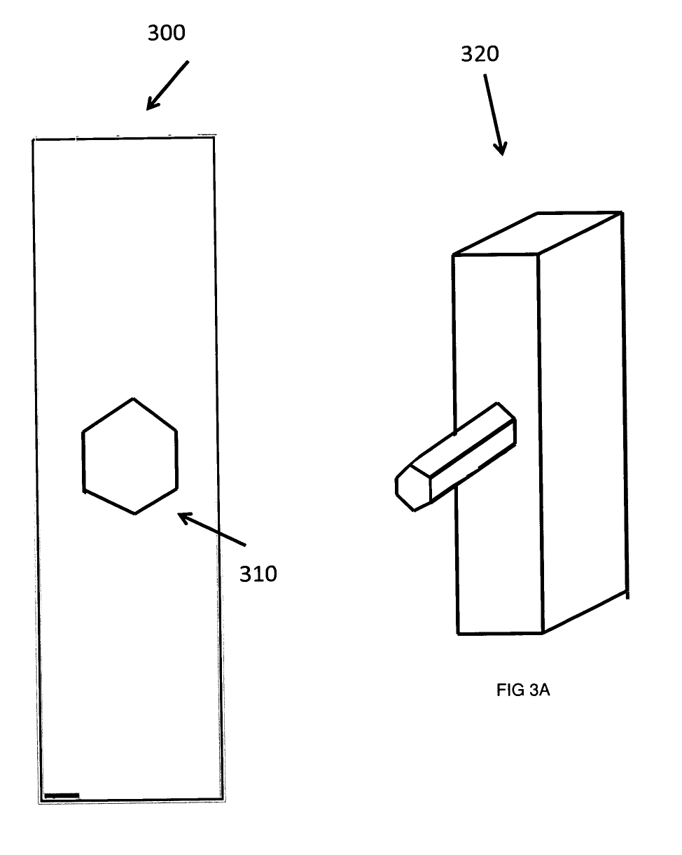

FIG. 3 is a bottom view of the axial shaft/slotted bracket as it lay on its depth side on a flat surface. 300 The slotted bracket has the same dimensions of FIG. 2. The ⅜″ axial shaft is 1.5″ long. 310

FIG. 3A is a perspective view of the axial shaft/slotted bracket on its depth side. 320 shows the 0.5″ depth. The ⅜″ axial shaft and is 1.5″ long opposite the insertable cavity 330.

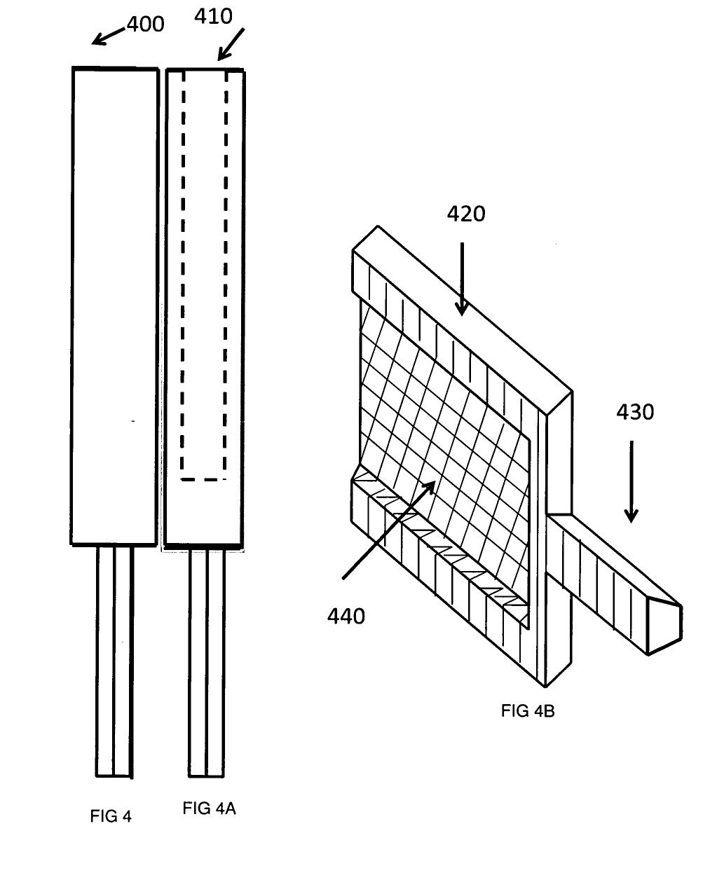

FIG. 4 is a side view of the axial shaft/slotted bracket as it lay on its depth side on a flat surface. 400 The axial shaft/slotted bracket has the same dimensions of FIG. 2. The axial shaft is 1.5″ long. 440 The cavity insertable slot is shown in 410 side view. FIG. 4A is a ½ cross cut perspective view of the axial shaft/slotted bracket on its depth side. 420 shows the 0.25″ depth which is ½ the depth of 0.5 the total depth as described in FIG. 3A. The ⅜″ axial shaft and is 1.5″ long opposite the insertable cavity 430. This cross cut view is ½ of the ⅜″ axial shaft. The insertable cavity 430 is 2.25″ in length 1.16″ width and 0.15 deep. This view shows a depth of ½ the 0.15″ deep which equals 0.075″. These dimensions are that of a working prototype. The prototype was produced on a 3D printer. The prototype is a plastic “mesh,” that is not solid. The end product, connector, will be solid plastic and injection molded. The end product and the mold may require some adjustments to the dimensions. The dimensions herein are within 0.08″ tolerance range.

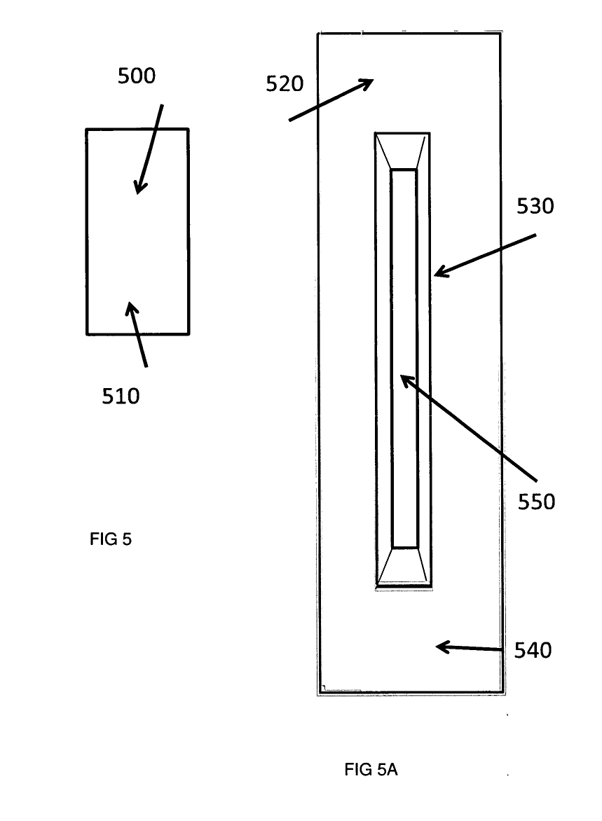

FIG. 5 This is a side view of the squeegee ring. The perspective is the same as FIG. 1, The side view is as it lay on its length and wide side on a flat surface. The slotted connector ring 500 has dimensions of 0.5″ length, by 1.58″ wide, by 0.5″ deep. If turned over and laid the same way the dimensions are the same 510. FIG. 5A shows the end views. The top view 520 shows the solid part of the ring 0.5 deep. 530 shows the cavity ring hole. 550 shows the view if turned over which is a mirror image. 540 also shows the solid part of the ring and 550 shows the ring hole. The ring hole cavity 550 is 1.16″ width and 0.15 deep. Since it is a hole it has no length.

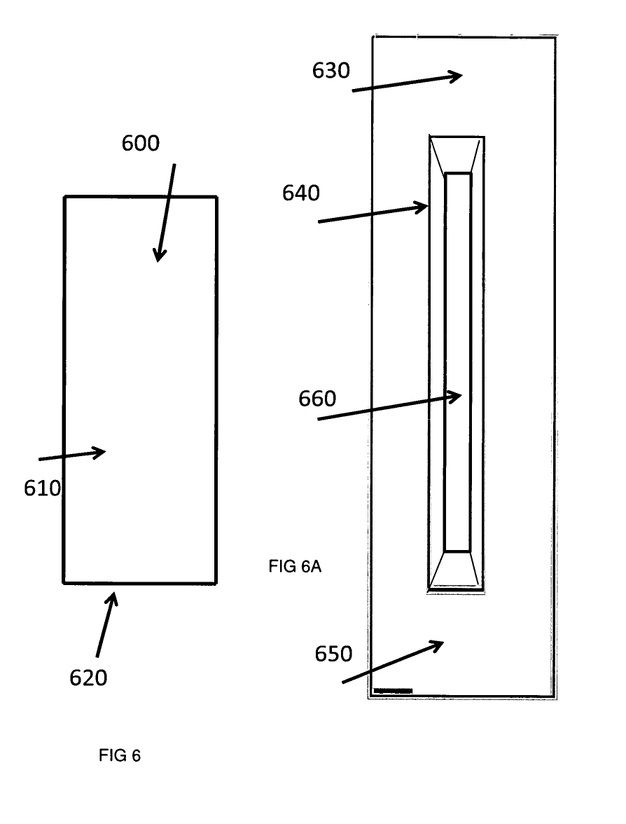

FIG. 6 This is a side view of the extension connector. The perspective is the same as FIG. 1, the side view is as it lay on its length and wide side on a flat surface. The slotted extension connector 600 has dimensions of 2.5″ length, by 1.58″ wide, by 0.5″ deep. If turned over and laid the same way the dimensions are the same 610. 620 points to the end of the connector where the cavity insertable slots are. FIG. 6A shows the end views. The top view 630 shows the solid part of the connector 0.5 deep. 640 shows the cavity insertable slots. 650 shows the view if turned over which is a mirror image. 650 also shows the solid part of the connector and 660 shows the cavity hole. The cavity hole cavity 660 is 1.16″ width and 0.15 deep. Since it is a hole it has no length.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What I claim is:

1. A connection device, for rotary mixing of viscous fluidic materials, comprising of:
a plurality of two side walls with equal length and width;
a plurality of two side walls of equal length and depth;
a plurality of two end walls of equal width and depth and
the plurality of the walls with dimensions form a rectangle box and being a one piece combination connector made of injection molded recyclable plastic having a hex shaft for connecting to a mixing device, eg: power drill on one end, and a rectangular box bracket, described above with a cavity insertable slot for connecting by insertion of a mixing stick, (paint stick) on the end opposite of the hex shaft.

2. A cleaning squeegee ring comprising of:
a plurality of two side walls with equal length and width;
a plurality of two side walls of equal length and depth;
a plurality of two end walls of equal width and depth and
the plurality of the walls with dimensions form a rectangle box and is one piece made of injection molded recyclable plastic with an insertable rectangular hole that is put on the mixing stick before mixing and slid down the stick to meet the connection device described in claim 1, and when mixing is complete the cleaning squeegee is slowly removed according to the instructions in the opposite direction of installation, thus providing the squeegee effect to the unused material forcing it back into the container for future use.

3. An extension device comprising of:
a plurality of two side walls with equal length and width;
a plurality of two side walls of equal length and depth;
a plurality of two end walls of equal width and depth and
the plurality of the walls with dimensions form a rectangle box and is one piece made of injection molded recyclable plastic with an insertable rectangular hole that is parallel to the length and slot dimensions of device in claim number one where the end of the first stick is inserted into the slot at one end of the hole and a second stick is inserted in opposite end of the hole to double the length of the mixing stick for stirring in larger, deeper containers. The use of the extension is optional.
